(19) United States
(12) Patent Application Publication
(10) Pub. No.: US 2005/0033891 A1
(43) Pub. Date: Feb. 10, 2005

(54) System and method for communication over a bus

(75) Inventor: Hamed Eshraghian, Lexington, MA (US)

Correspondence Address: WILMER CUTLER PICKERING HALE AND DORR LLP, 60 STATE STREET, BOSTON, MA, 02109, US

(73) Assignee: Starent Networks, Corp.

(21) Appl. No.: 10/859,783

(22) Filed: Jun. 3, 2004

Related U.S. Application Data
(60) Provisional application No. 60/475,561, filed on Jun. 3, 2003.

(51) Int. Cl. G06F 13/42

(52) U.S. Cl. 710/305

(57) ABSTRACT

Systems and methods for communicating data over a communication bus are disclosed. In some aspects, the data is digital information communicated over a multiple-line bus connecting two or more electronic devices such as integrated circuits. The disclosure presents useful formats for arranging data into data cells communicated over the bus, and include some exemplary features as shared clock signals, Ready bit information, and vertical parity checking.

### CROSS-REFERENCE TO RELATED APPLICATIONS

This application claims the benefit, under 35 U.S.C. 119(e), of U.S. Provisional Patent Application No. 60/475,561, filed on Jun. 3, 2003, entitled F8 Bus Specification, which is hereby incorporated by reference.

### TECHNICAL FIELD

The present application relates to systems and methods for exchanging electrical signals, and in particular to the communication of digital information between two or more electronic components over a communication bus.

### BACKGROUND

Electrical and electronic circuits and systems, and elements thereof, exchange electrical signals. The signals can be in analog form, generally signified by a magnitude of some characteristic of the signal, e.g. voltage. Alternately, the signals can be in digital form, signified by discrete values of the signal, e.g. binary signals (0/1, +1/−1, high/low, etc.).

Modern electronic systems commonly exchange digital information over conducting lines or wires, often arranged in groups, called buses. A bus can contain any number of conducting lines, and can be formed by grouping the conducting lines physically or logically. Buses can be produced in bundles, braids, or flat ribbons, and can have endpoint connectors or terminators suitable for making contact between the components coupled by the buses. Buses can also be produced by laying out solder lines on an electronic circuit board, or by etching conductive traces into a semiconducting substrate. When packaged in a chip, buses can be manufactured along with the chip in the package.

One communication bus provided by the Common Switch Interface Consortium is known as the CSIX bus, used in network processors. The CSIX bus provides lines for data communication, including header information, a Ready bit, and vertical parity checking bits. Another available communication bus is the proprietary Focus bus from Vitesse Semiconductor Corporation. The Focus bus provides data lines, header information, but no Ready bit or vertical parity information. Both the CSIX and Focus buses require flow control data to be exchanged outside the buses, on separate lines, which consume valuable bus and pin locations. The CSIX bus requires start-of-frame (SOF) and parity (PAR) lines in addition to clock and data lines. The Focus bus requires flow control lines in addition to clock and data lines.

As features, functions, and communication bandwidths multiply, it becomes helpful or necessary to optimize or efficiently make use of the communication buses in electronic systems and devices. Accordingly, data is usually packaged and delivered in a way that leaves as much bandwidth over the buses available as possible while still achieving the desired function.

One way to address the problem of limited bus connections might be to increase the number of communication data lines (lines) in the buses. However, this would require a corresponding increase in the number of connecting pins coupling the devices to the buses, and would also require a corresponding modification to the communication protocols, memory array sizes, communication software, clock regulation, and other design factors. Furthermore, increasing the size of communication buses results in buses and devices that are significantly larger in physical area (footprint) and cost. Therefore, it is useful to develop new systems and techniques that reduce the need for added buswork and connections, and efficiently utilize the lines and pin connections of existing systems.

### SUMMARY

Recognizing at least the points mentioned above, and appreciating solutions to the challenges presented by modem digital bus communications, new systems and methods for communicating over buses are described. In some aspects, the buses provide improved bus availability, bandwidth, and performance by utilizing common clock signals instead of conventional clock sourcing. In other aspects, the buses use useful and new cell formats that enable devices to exchange information and payloads in a streamlined fashion within existing hardware limitations that are less prone to error. In some specific embodiments, a bus and method for using the same is provided to satisfy the “F8” bus used in the ST-16 intelligent mobile gateway device from Starent Networks of Tewksbury, Mass., or similar devices. More generically, the present buses and methods may be used with any compatible or adaptable components, the digital communication and signal processing types being only one example thereof.

One embodiment of the present disclosure is directed to a method for exchanging digital data between devices over a bus, including providing at least one bit of data to indicate the type of digital data being exchanged; providing at least one bit of data to indicate whether a device coupled to the bus is ready to communicate with other devices over the bus; and providing at least one vertical parity bit for checking for error conditions in corresponding bits of the digital data.

Another embodiment of the present disclosure is directed to a system for transferring digital data between at least two devices, including a communication bus having a plurality of communication lines, the communication bus coupled at a first end thereof to a first device and coupled at a second end thereof to a second device; at least one of the plurality of communication lines carrying a bit of data to indicate the type of digital data being exchanged; at least one of the plurality of communication lines carrying a bit of data to indicate whether a device coupled to the communication bus is ready to communicate with other devices over the communication bus; and the plurality of communication lines carrying vertical parity bits for checking for error conditions in corresponding bits of the digital data.

### BRIEF DESCRIPTION OF THE DRAWINGS

For a fuller understanding of the nature and objects of the present disclosure, reference should be made to the following detailed description, in connection with the accompanying drawings, in which the same reference numerals are used to indicate the same or similar parts, wherein:

FIG. 1 illustrates an exemplary grouping of FPGA circuits arranged on a motherboard and interconnected by communication buses;

FIG. 2 illustrates an 8-bit byte of a data cell, with notation for numbering the bits;

FIG. 3 illustrates an exemplary F8 cell format, showing the information contained in each byte and bit of the cell;

FIG. 4 illustrates the operation of vertical parity in a data cell;

FIG. 5 illustrates data blocks within an exemplary F8 data cell, including payload cells; and

FIG. 6 illustrates a null cell.

### DETAILED DESCRIPTION

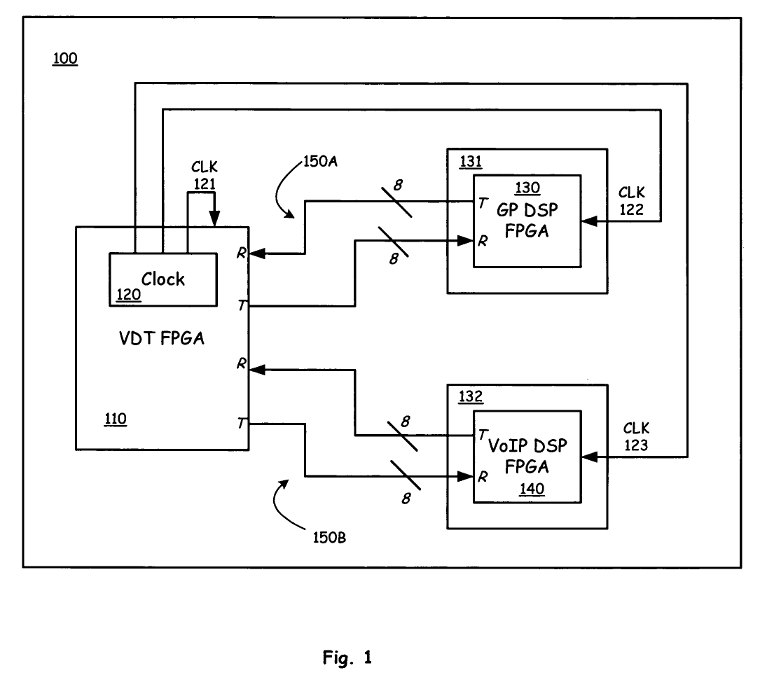

FIG. 1 illustrates an exemplary motherboard 100 having various logic chips, circuits, and communication elements coupled thereto. Motherboard 100 is typically provided with connection pins (not shown) that deliver power, ground connections, data, and control signals between the motherboard and a computer system in which the motherboard is installed. The computer system may be local and has motherboard 100 installed into a hardware slot designed for such cards. The computer system may be also be remote or distributed such that motherboard 100 and the computer system are not in physical proximity to one another.

The motherboard 100 of FIG. 1 includes a voice data transport (VDT) field programmable gate array (FPGA) chip 110 that manages aspects of delivery and processing of information from voice communication sessions. Two other FPGAs are disposed on motherboard 100: a general purpose digital signal processing (GP DSP) chip 130 and a voice over internet protocol digital signal processing (VoIP DSP) chip 140. The chips in this example are constructed as packaged integrated circuits (ICs) and are generally mounted on cards or daughter boards, e.g. 131, 132, which themselves are electrically and/or mechanically coupled to motherboard 100, but the FPGAs may also be placed directly onto appropriate mating connections on motherboard 100.

Each of the FPGAs 130 and 140 are connected to FPGA 110 by “F8” communication bus lines 150. An F8 bus has 16 total lines, consisting of 8 lines for receiving data, and another 8 lines for transmitting data. This is indicated by the slash symbols accompanying the numerals “8” in the figures, as well as the directionality of the arrows and the letters “R” (receive) and “T” (transmit). F8 bus 150A connects VDT 110 and GP DSP 130, while F8 bus 150B connects VDT 110 and VoIP DSP 140. Of course, not all buses connecting the various components need to be of the same design or of the F8 type, but rather, it is possible to have a variety of bus types represented on a single board or system if appropriate.

This system of integrated circuits and associated computing components provides the ability to receive, process, store, and retransmit digital data from a variety of sources and in one or more formats. For example, the circuits may be used to handle voice and data communication in internet protocol (IP), asynchronous transfer mode (ATM), or time division multiplexing (TDM) applications.

One feature, of one aspect of the invention, shown in FIG. 1 is a shared clock feature. A clock source, usually a solid state resonator crystal 120 is powered from some source of power on a daughter board or a motherboard 110. The clock 120 generates a cyclical (CLK) signal suitable for actuating and synchronizing other parts of the system. In the exemplary embodiment shown, the clock signal is delivered to the FPGAs 110, 130, and 140 through clock lines 121, 122, and 123, respectively. The clock signals to all of the FPGAs are thus shared from their source 120 and will be substantially synchronized (having contemporaneous rising and falling edges).

In some instances, the present system of sharing a common clock signal is preferable to conventional clock sourcing. In conventional clock sourcing, a clock signal is generated at a clock and then passed to a first circuit. The first circuit in turn passes on a clock signal to a second circuit, which may pass a clock signal to a third, and so on. Clock sourcing works by a two-way (back and forth) communication between the circuits. Therefore, clock sourcing requires two lines dedicated to the exchange of clock signal information. By contrast, and as can be seen in FIG. 1, a shared clock signal method only requires a single clock line per clocked device (121, 122, 123), and provides a savings of one communication line at each of the circuits. Therefore, in shared or common clocked embodiments, an extra communication line is freed up to be used for other communication functions or data transfer.

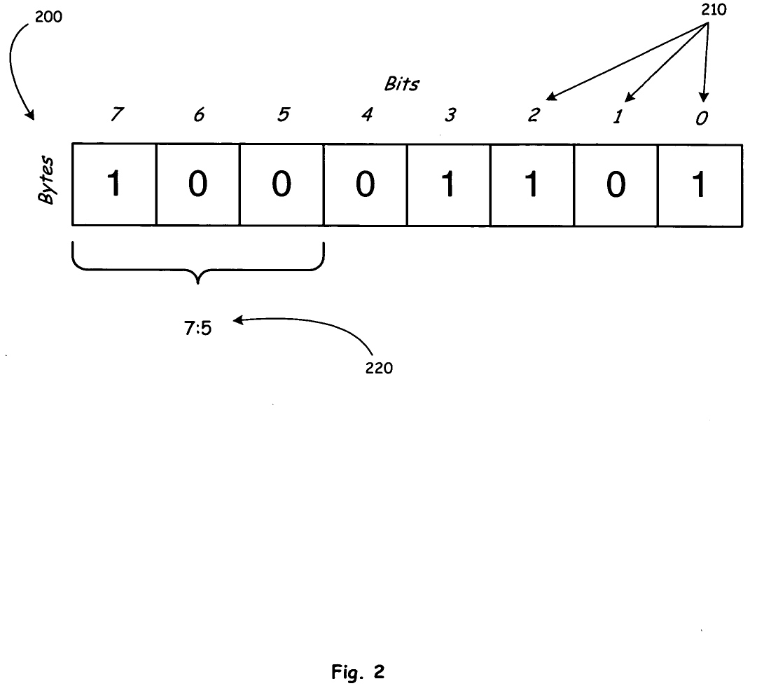

We now turn to the use of the communication buses 150 according to some embodiments of the invention. As mentioned earlier, a double-eight communication bus, such as the F8 bus, can be used to communicate digital information bits between two circuits or components. The communication is performed according to a pre-determined format so that the two communicating components may properly parse the significance of the information. As a preliminary step, a convention for illustrating and describing the information content is shown in FIG. 2. An exemplary byte 200 is shown having 8 bits 210. The bits are designated sequentially from 0 to 7. Each bit (binary digit) carries a “0” or a “1” (or their equivalent) information. In the example, bit number 0 carries a “1” datum of information, bit number 1 carries a “0” datum of information, bit number 2 carries a “1” datum of information, etc. The entire 8-bit byte 200 carries the data “10001101.” The bus 150 is usually “unconcerned” with the actual data it carries, and the communicating circuits are the elements that will parse and process the information sent and received over the bus. In the present description, a short hand notation 220 is used to indicate a group of bits carrying information of some significance. Figure 2 provides an example of a group of bits “100” carried in bit 7 through bit 5 of byte 200. This group of bits is indicated by the notation “7:5” or seven-through-five. This notation will be used below to describe the use of the bytes and what information is delivered in an exemplary F8 format.

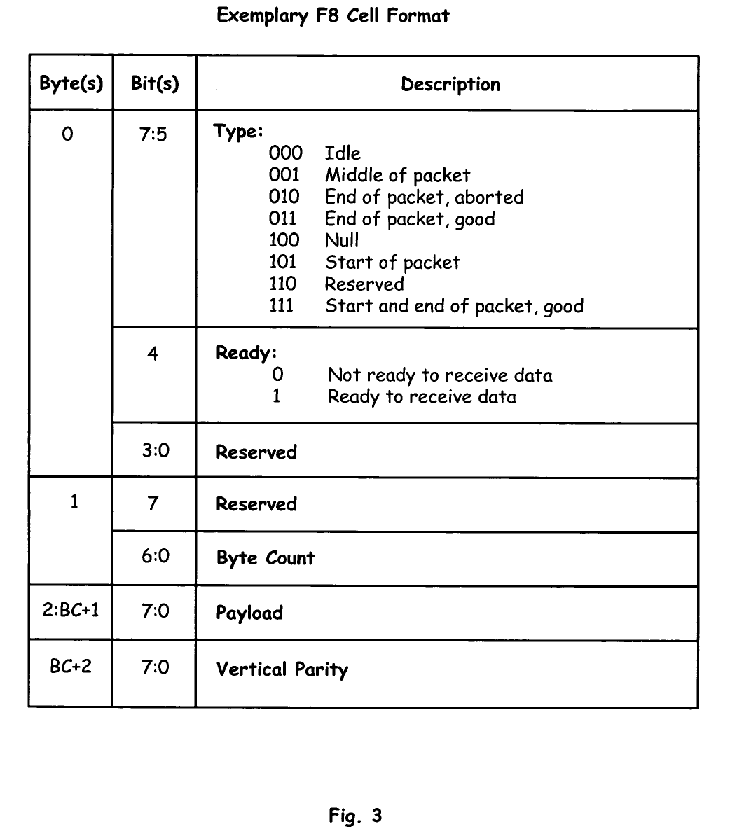

FIG. 3 illustrates an exemplary format of a cell of information comprising several 8-bit bytes. Data strings, structures, and words of other size and other orderings of the information within the cell are possible and can be implemented by those skilled in the art. In the F8 example cell format, the first byte (byte 0) carries three pieces of information:

First, in bits 7:5, the type of cell. The figure shows several types of cell types that can be indicated by the 7:5 bits of byte 0. The are:

| | |
|---|---|
| 000 | Idle - the bus is not carrying information (is in an idle state) |
| 001 | Middle of packet - portions of a data packet precede and follow |
| 010 | End of packet, aborted packet |
| 011 | End of packet, good packet |
| 100 | Null - no payload present, for flow control uses |
| 101 | Start of packet |
| 110 | Reserved |
| 111 | Start and end of packet, good packet having only one cell |

Second, in bit number 4 of byte number 0, a “Ready” bit is carried. If the value of the Ready bit is “0” then the device is not ready to receive data from the bus. If the value of the Ready bit is “1” then the device is ready to receive data.

Third, bits 3:0 are reserved, and not used by the devices.

The next byte (byte 1) carries the Byte Count (BC), or number of bytes of payload data in the cell, in bits 6:0, with bit 7 being reserved. The byte count is an integer number, represented in a 7-bit binary format in the present example.

It should be appreciated that more than one byte may be used to signify the number of payload bytes in the cell. This could be used if the number of payload bytes is too large to be represents by the bits in a single Byte Count byte or portion thereof.

The final byte (number BC+2) is for vertical parity (VP). Parity bits are used for error checking. Errors arise in digital communication from a variety of sources. For example, electrical interference can cause a “0” bit to arrive at its destination as a “1” bit, or vice versa. A parity sense is adopted to check for flipped bits. Even vertical parity means that an even number of “1”s were packaged in a column of cells at its origin, and odd vertical parity means that an odd number of “1”s were packaged in a column of cells at its origin.

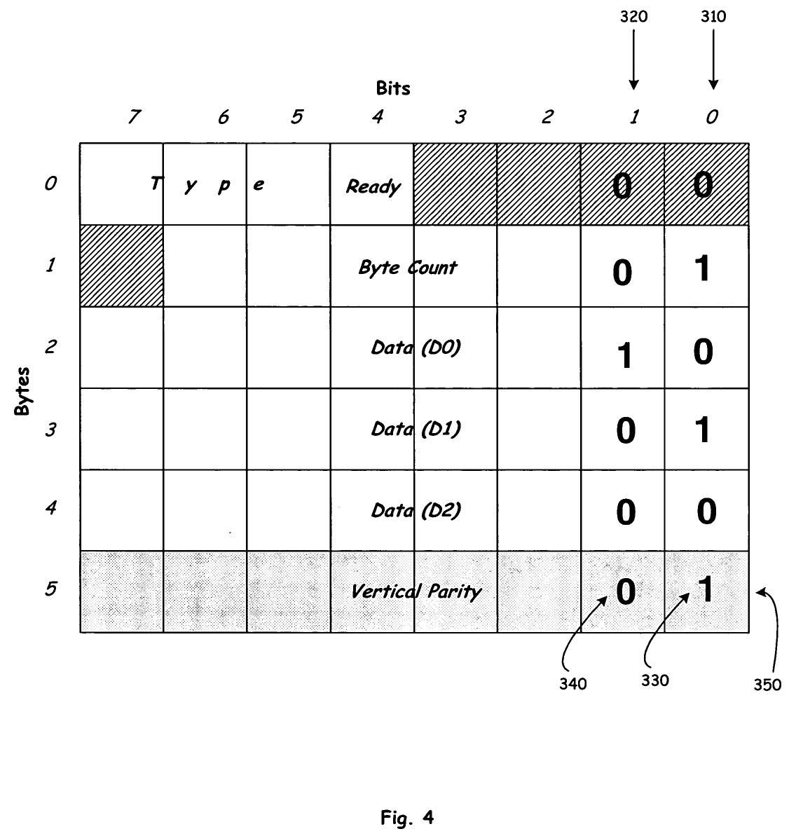

FIG. 4 illustrates an exemplary F8 cell similar to that described above, having odd parity error checking. Data content of the first two columns 310, 320 are shown for illustrative purposes, while the rest of the cell's data values are not shown for simplicity. The last row 350 of cell 300 contains the VP bits. Bits 330 and 340 contain the VP bits for columns 310 and 320, respectively. Each VP bit is made to produce an odd total number of “1”s in its column. Hence, bit 330 is a “1” because its column contains two other “1”s, and a “1” is needed in VP bit location 330 to make the number of “1”s for column 310 equal 3, an odd number. Likewise, in column 320, VP bit 340 is made to be a “0” because the column 320 otherwise contains one “1” value, which is an odd number of “1”s. The VP bits in the other six positions of row 350 would similarly be made to be “0” or “1” as necessary to keep the total number of “1”s per column of the cell odd. If the figure was for an even parity configuration, the “1”s and “0”s of the VP row 350 would be interchanged.

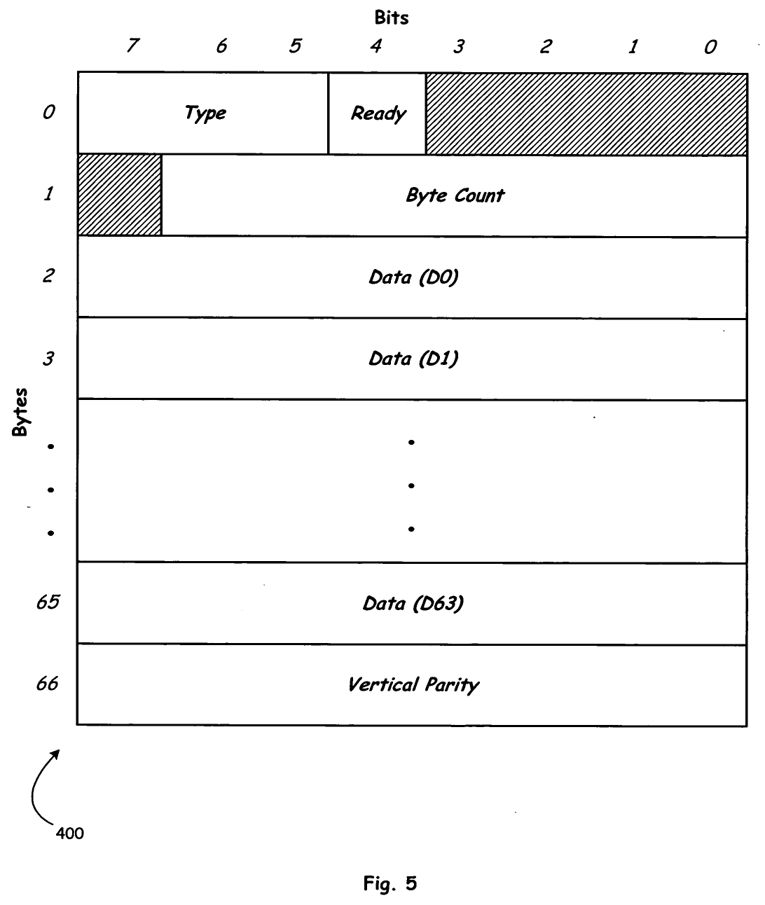

FIG. 5 illustrates another F8 cell 400 according to the present exemplary format, showing blocks of bits in each byte of the cell signifying various content. The shaded blocks of bits are reserved or unused. The cell illustrated in FIG. 5 includes 64 8-bit data (payload) bytes, D0 . . . D63. In some embodiments, this number of payload bytes facilitates communication with components using the TDM format or IP packet format. Other embodiments could have less, more, or no payload cells.

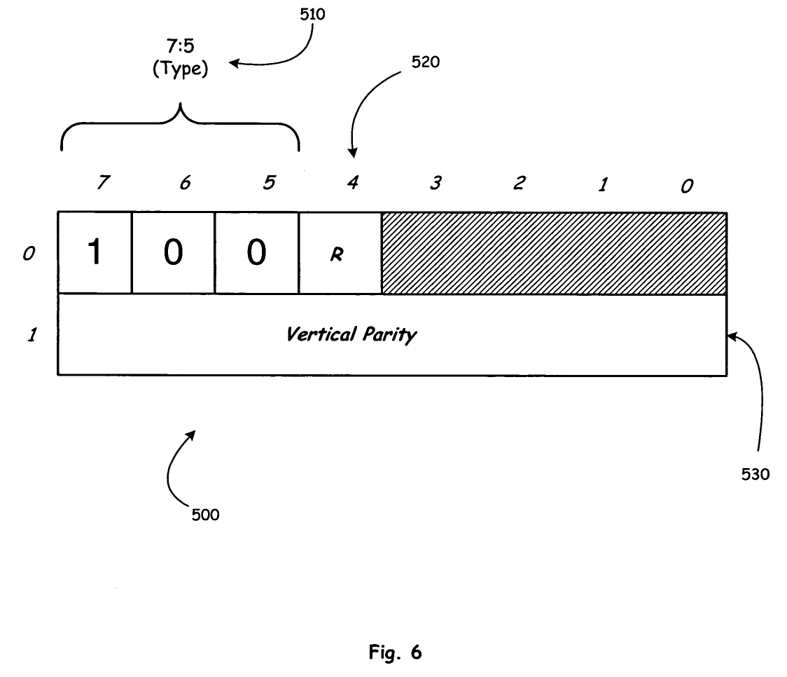

FIG. 6 illustrates a “null” cell 500. Byte 0 includes the Type of cell in bits 7:5 as described previously. This type according to the example used is defined by bit values “100” in the 5:7 bits 510. The Ready bit 520 follows in bit 4 of byte 0. Byte 1 of null cell 500 is used for vertical parity. No payload data is carried in a null cell, but it does carry the Ready bit to indicate the availability of the device.

As described in the present disclosure and figures, new communication buses and methods for carrying data over the buses have been presented. In some aspects, shared clocking of interconnected devices provides a savings in lines used for clock signals to the devices. In other aspects, data cell formats including flow control functionality and being indicative of the type of data cell, including whether the data cell is a null cell are provided. In yet other aspects, the disclosure teaches a way to populate a data cell with binary information suitable for use with the F8 bus and compatible systems. The systems and methods include provisions for error checking using vertical parity, and improve the overall performance and pin/line availability to devices communicating over the bus lines. Therefore, increased functionality and lower cost can be achieved in digital communication systems using such buses.

Upon review of the present description, figures, and specific exemplary embodiments, it will be understood that modifications and equivalent substitutions may be performed in carrying out the invention without departing from the essence of the invention. Thus, the invention is not meant to be limited by the embodiments described explicitly above, rather it should be construed by the scope of the claims that follow.

1. A method for exchanging digital data between devices over a bus, comprising:
providing at least one bit of data to indicate the type of digital data being exchanged;
providing at least one bit of data to indicate whether a device coupled to the bus is ready to communicate with other devices over the bus; and
providing at least one vertical parity bit for checking for error conditions in corresponding bits of the digital data.

2. The method of claim 1, further comprising logically grouping the digital data into a data cell.

3. The method of claim 1, further comprising including any flow control data within the data cell.

4. The method of claim 1, further comprising at least one byte of data for carrying an information payload across the bus.

5. The method of claim 4, further comprising at least one bit of data to indicate a number of bytes of data carrying an information payload.

6. The method of claim 1, wherein the at least one bit of data to indicate the type of digital data being exchanged comprises at least one combination of bits to indicate that the digital data is of a null type, carrying no payload therein.

7. The method of claim 1, further comprising clocking the devices using a common clock signal.

8. A system for transferring digital data between at least two devices, comprising:
a communication bus having a plurality of communication lines, the communication bus coupled at a first end thereof to a first device and coupled at a second end thereof to a second device;
at least one of the plurality of communication lines providing at least one bit of data to indicate the type of digital data being exchanged;
at least one of the plurality of communication lines providing at least one bit of data to indicate whether any of the devices coupled to the communication bus are ready to communicate with other devices over the communication bus; and
the plurality of communication lines providing vertical parity bits for checking for error conditions in corresponding bits of the digital data.

9. The system of claim 8, further comprising a clock input line of a first device, said clock input line providing a clock signal that is shared with clock input lines on at least one other device.

10. The system of claim 8, further comprising at least one of the plurality of communication lines providing flow control data.

11. The system of claim 8, being further constructed as part of an integrated circuit for use in a communication computer system.

12. The system of claim 11, wherein the system receives communication data according to a communication standard format.

13. A method for generating a digital data cell to be sent from a first device to a second device over a communication bus, the cell comprising:
a byte including a descriptor of the type of digital data cell;
a byte including at least one bit to indicate that the first device is ready to exchange digital data with the second device;
at least one byte to indicate a number of information payload bytes in the digital data cell;
at least one byte carrying information payload data; and
a byte of data including a plurality of vertical parity bits corresponding to the other bytes of data in the digital data cell.

14. The method of claim 13, wherein the byte including a descriptor of the type of digital data cell, and the byte including at least one bit to indicate that the first device is ready to exchange digital data with the second device, comprise a same byte that includes both the descriptor of the type of digital data cell and the at least one bit to indicate that the first device is ready.
